(19) United States
(12) Patent Application Publication
(10) Pub. No.: US 2016/0063327 A1
(43) Pub. Date: Mar. 3, 2016

(54) Wearable Device To Display Augmented Reality Information

(71) Applicant: daTangle, Inc., Milpitas, CA (US)

(72) Inventor: Taizo Yasutake, Cupertino, CA (US)

(73) Assignee: daTangle, Inc., Milpitas, CA (US)

(21) Appl. No.: 14/840,980

(22) Filed: Aug. 31, 2015

Related U.S. Application Data
(60) Provisional application No. 62/070,563, filed on Aug. 29, 2014.

(51) Int. Cl. G06K 9/00; H04N 7/18; G06F 1/16; G06T 11/60

(52) U.S. Cl. CPC G06K 9/00671; G06T 11/60; H04N 7/183; G06F 1/163; G06T 2215/16

(57) ABSTRACT

A wearable device configured to display augmented reality (AR) information to a user wearing the wearable device is disclosed. The wearable device includes a screen and a set of mirrors including a first mirror and a second mirror. The screen is configured to display an overlay AR image including AR information associated with a real world scene of a surrounding environment of the user. The first mirror is configured to reflect the overlay AR image displayed on the screen to the second mirror. The second mirror is configured to simultaneously a) receive and reflect the overlay AR image reflected by the first mirror and b) transmit the real world scene, such that the second mirror displays a mixed image of the AR information and the real world scene to the user.

### PRIORITY CLAIM AND RELATED APPLICATION

This application claims priority to U.S. Provisional Application No. 62/070,563, entitled “A Wearable Device to Display Augmented Reality Information,” filed Aug. 29, 2014.

### FIELD OF THE APPLICATION

The present application generally relates to the fields of wearable devices and computer technologies, and more particularly to a method and apparatus for providing a wearable device to display augmented reality (AR) information to a user.

### BACKGROUND

Nowadays, some known conventional wearable devices are used to execute AR applications and/or display AR information to a user. Such known conventional wearable devices include, for example, Google Glass, Vuzix M100, Epson Moverio, etc. Such a known conventional wearable device typically consists of a pair of micro display monitors with a set of mirrors and lens or a tiny monitor for a single eye of a user. The hardware designs of those known conventional wearable devices, however, generally have some limitations from an ergonomic design viewpoint. For example, the hardware of those known conventional wearable devices is typically bulky, heavy to wear, and/or difficult to wear for users that are wearing conventional eye glasses.

Therefore, a need exists for a wearable device configured to display AR information to a user that overcomes the above design limitations and provides highly light-weighted hardware with a reasonable manufacturing cost.

### SUMMARY

The above deficiencies associated with the known conventional wearable devices may be addressed by the techniques described herein.

In some embodiments, a wearable device configured to display AR information to a user wearing the wearable device is disclosed. The wearable device includes a screen and a set of mirrors including a first mirror and a second mirror. In some instances, the screen can be an organic light-emitting diode (OLED) screen, the first mirror can be a full-reflective mirror, and the second mirror can be a half-silvered mirror. In some instances, the distance between the second mirror and eyes of the user is movably adjustable.

The screen is configured to display an overlay AR image including AR information associated with a real world scene of a surrounding environment of the user. In some instances, the wearable device is configured to receive the overlay AR image from a mobile device of the user. The first mirror is configured to reflect the overlay AR image displayed on the screen to the second mirror. The second mirror is configured to simultaneously a) receive and reflect the overlay AR image reflected by the first mirror and b) transmit the real world scene, such that the second mirror displays a mixed image of the AR information and the real world scene to the user. In some instances, the second mirror is configured to receive the overlay AR image from the first mirror when the set of mirrors are in an open state, and the second mirror is configured not to receive the overlay AR image from the first mirror when the set of mirrors are in a closed state.

In some instances, the wearable device further includes a camera and a processing device. The camera is configured to capture the real world scene. The processing device is configured to identify the AR information and to generate the overlay AR image based on the captured real world scene. In such instances, the camera can be configured to generate an image of the real world scene and the processing device can be configured to identify the AR information and to generate the overlay AR image using the image as an input.

Alternatively, in some other instances, the wearable device further includes a camera and a connector. The camera is configured to capture the real world scene. The connector is configured to send information of the captured real world scene to a mobile device of the user and receive the overlay AR image from the mobile device of the user.

In some embodiments, a method of displaying AR information to a user wearing a wearable device is disclosed. The method is performed by components of the wearable device. The method includes displaying, on a screen of the wearable device, an overlay AR image including AR information associated with a real world scene of a surrounding environment of the user. The method also includes reflecting the overlay AR image displayed on the screen onto a first mirror of the wearable device and further onto a second mirror of the wearable device. The method further includes displaying, at the second mirror, a mixed image of the AR information and the real world scene to the user.

In some instances, the method includes, prior to displaying the overlay AR image on the screen, capturing the real world scene of the surrounding environment of the user, and then identifying the AR information and generating the overlay AR image based on the captured real world scene. In such instances, the method can include generating an image of the real world scene using a camera of the wearable device.

Alternatively, in some other instances, the method includes, prior to displaying the overlay AR image on the screen, receiving the overlay AR image from a mobile device of the user. Additionally, in yet some other instances, the method includes, prior to displaying the overlay AR image on the screen, capturing the real world scene of the surrounding environment of the user, then sending information of the captured real world scene to a mobile device of the user, and lastly receiving the overlay AR image from the mobile device of the user.

Various advantages of the present application are apparent in light of the descriptions below.

### BRIEF DESCRIPTION OF DRAWINGS

The aforementioned implementation of the present application as well as additional implementations will be more clearly understood as a result of the following detailed description of the various aspects of the application when taken in conjunction with the drawings.

FIG. 1A is a schematic diagram illustrating a perspective view of a wearable device and its components in accordance with some embodiments.

FIG. 1B is a schematic diagram illustrating a perspective view of the wearable device in FIG. 1A being worn by a user.

FIG. 2A is a schematic diagram illustrating a set of mirrors in the wearable device in FIG. 1A being in a closed state.

FIG. 2B is a schematic diagram illustrating the set of mirrors in the wearable device in FIG. 1A being in an open state.

FIG. 2C is a schematic diagram illustrating a side view and a top view of the set of mirrors in the wearable device in FIG. 1A being in the closed state.

FIG. 2D is a schematic diagram illustrating a side view and a perspective view of the set of mirrors in the wearable device in FIG. 1A being in the open state.

FIG. 2E is a schematic diagram illustrating a side view of the set of mirrors in the wearable device in FIG. 1A and light paths reflected by the set of mirrors.

FIG. 2F illustrates a mixed AR image displayed on a mirror of the wearable device in FIG. 1A.

FIG. 3A is a schematic diagram illustrating a perspective view of another wearable device in accordance with some embodiments.

FIG. 3B is a schematic diagram illustrating a perspective view of yet another wearable device in accordance with some other embodiments.

FIG. 3C is a schematic diagram illustrating the wearable device in FIG. 3B being worn by a user.

FIG. 4 is a schematic diagram illustrating a wearable device with a solar panel in accordance with some embodiments.

FIG. 5 is a schematic diagram illustrating a wearable device with a mobile device in accordance with some embodiments.

FIGS. 6A and 6B are schematic illustrations of a sliding feature for a set of mirrors in a wearable device in accordance with some embodiments.

FIG. 7A is a block diagram illustrating components and modules of the wearable device in FIG. 1A and/or 3A.

FIG. 7B is a block diagram illustrating components and modules of the wearable device in FIG. 3B.

FIG. 8A is a schematic illustration of a mobile device configured to generate an overlay AR image for the wearable device in FIG. 3B.

FIG. 8B is another schematic illustration of a mobile device configured to generate an overlay AR image in accordance with some embodiments.

FIG. 9A is a schematic diagram illustrating a perspective view of a camera of the wearable device in FIG. 1A and an image of a real world scene captured by the camera.

FIG. 9B illustrates the captured image of the real world scene in FIG. 9A from another view angle.

FIG. 9C illustrates processing the captured image of the real world scene in FIG. 9A to identify an AR object.

FIG. 9D illustrates an overlay AR image as a result of the processing shown in FIG. 9C.

FIG. 9E illustrates a mixed image of the real world scene and the overlay AR image in FIG. 9D.

FIG. 9F is a schematic diagram illustrating the set of mirrors in the wearable device in FIG. 1A generating the mixed image in FIG. 9E.

FIG. 10 is a schematic illustration of mixing an overlay AR image with a real world scene in accordance with some embodiments.

FIG. 11 is another schematic illustration of the mixing process shown in FIG. 10.

Like reference numerals refer to corresponding parts throughout the several views of the drawings.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

In some embodiments, a wearable device described herein can overcome the design limitations of the known conventional wearable devices (e.g., Google's Google Glass, Vuzix M100, Epson Moverio, etc.) and provide highly light-weighted hardware with a reasonable manufacturing cost. In such embodiments, the hardware design of the wearable device adopts a physical structure of visor or cap that is usually used for sports. Furthermore, two different kinds of mirrors are installed on the brim of the visor or cap. In some instances, the first mirror is a reflective (or fully-reflective) mirror that reflects 100% or substantially 100% of incident light, while the second mirror is a half-silvered mirror (or half mirror, half-reflective mirror, etc.) that reflects a portion of (e.g., 50%) incident light and transmits a portion of (e.g., 50%) light from the environment. Such a half-silvered mirror can display AR information received from a screen of the wearable device while simultaneously providing a “see-through” image of a real world scene. In some embodiments, the second mirror functions as a display panel of the wearable device.

The innovative features and advantages of the wearable device described herein include, for example: a low cost design that is suitable to the manufacturing of computer peripherals for the consumer market; a light-weighted hardware concept that provides an optimal product for AR display from an ergonomic viewpoint; a highly-simplified optical design that provides a relatively large AR display image in front of human eyes without any artificial correction of eye focusing; adoption of a flexible enclosure on the light path between the screen and mirrors that provides a clear vision of the AR information by avoiding image disturbance from ambient light; a sliding feature of the mirror set that provides a fine tuning of AR image focus to obtain ergonomically comfortable display in the half-silvered mirror; an ergonomic design to allow users already wearing her own glasses to wear the wearable device easily and comfortably; a hardware design that easily allows the installation of an extra power source (e.g., a solar panel) to expand the maximum time length for a continuous operation; etc.

To promote an understanding of the objectives, technical solutions, and advantages of the present application, embodiments of the present application are further described in detail below with reference to the accompanying drawings.

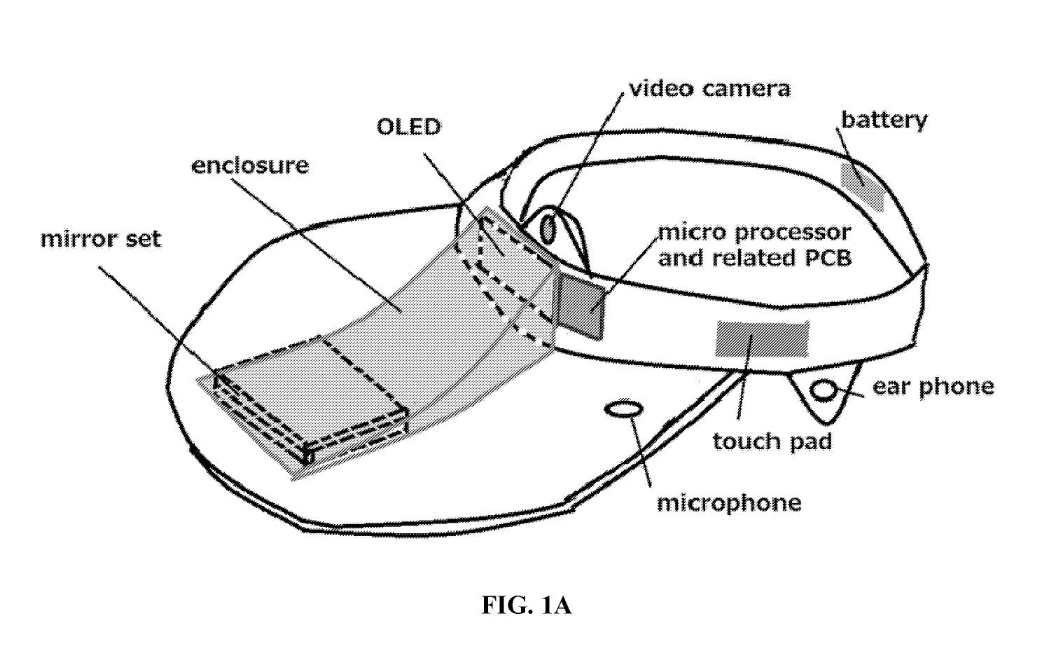

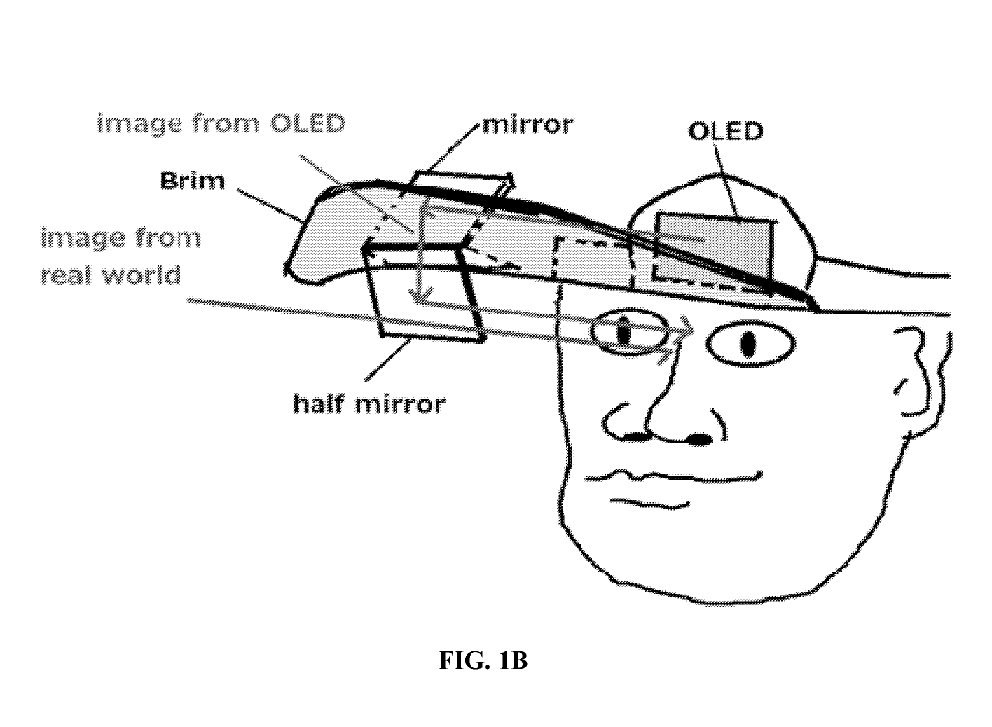

FIG. 1A is a schematic diagram illustrating a perspective view of a wearable device and its components in accordance with some embodiments. FIG. 1B is a schematic diagram illustrating a perspective view of the wearable device in FIG. 1A being worn by a user. As shown in FIGS. 1A and 1B, the wearable device uses a conventional visor, hat or cap for sports as its main hardware body. The wearable device includes an OLED screen and a set of two mirrors, where the OLED screen is installed at the front edge of the base of the wearable device and the set of mirrors is installed at the brim of the wearable device. The mirror on the top (referred to as the first mirror herein) can be a reflective or fully-reflective mirror (identified as “mirror” in FIG. 1B), while the mirror under the first mirror (referred to as the second mirror herein) can be a half-silvered mirror (identified as “half mirror” in FIG. 1B). In some embodiments, the wearable device can include any other suitable type of screen such as, for example, a LCD (liquid crystal display) screen.

The wearable device also includes a flexible enclosure configured to make a disturbance-free light path from the OLED screen to the set of mirrors, particularly to the first mirror (e.g., when the first mirror is in an open state). In some embodiments, in order to block light from outside light sources (e.g., the sun), such a flexible enclosure can be made of, for example, a thick, dark-colored fabric material (e.g., cloth) and installed to enclose the path connecting the OLED screen and the mirror set (as shown in FIG. 1A). Thus, the flexible enclosure can protect the mirror set from light disturbance (e.g., strong illumination) on the light path between the OLED screen and the mirror set.

As shown in FIG. 1A, the wearable device can include other components such as, for example, a microphone, a touch pad, a camera (e.g., a video camera), a processing device (e.g., a microprocessor and related PCB (printed circuit board)), an ear phone, a battery, etc. The electronic components of the wearable device can be controlled by the microprocessor-based PCB, and powered by the battery. In some embodiments, the wearable device can include more or less components as shown in FIG. 1A. For example, although not shown in FIG. 1A, the wearable device can include a USB (universal serial bus) port, a GPS (global positioning system) sensor, a WiFi communication antenna, and/or the like. For another example, the ear phone and the microphone can be optional electronic devices for voice input/output interaction and control. In other words, the wearable device can operate without an ear phone and/or a microphone.

FIG. 1B shows the wearable device being in an operational state to display AR information to the user. Specifically, as shown in FIG. 1B, the OLED screen displays an overlay AR image, which includes AR information associated with a real world scene that can be seen by the user. The real world scene is in front of the user, and can be seen by the user when the user looks ahead. In other words, as shown in FIG. 1B, the real world scene is the scene that can be seen by the user when the user looks to the direction of the second mirror (i.e., looking through the second mirror as if the second mirror were not there).

Next, the overlay AR image displayed on the OLED screen is reflected onto the first mirror, and further onto the second mirror. As a result of being reflected by the first mirror and the second mirror subsequently, the overlay AR image is reflected into the direction towards the user's eyes. That is, the user can see the overlay AR image reflected by the second mirror. Meanwhile, since the second mirror is half-silvered, the user can also see the real world scene which is transmitted through the second mirror. Consequently, the overlay AR image is mixed with the real world scene at the second mirror, and as a result, the user is able to see a mixed image of the AR information and the real world scene when he looks to the direction of the second mirror (as shown in FIG. 1B).

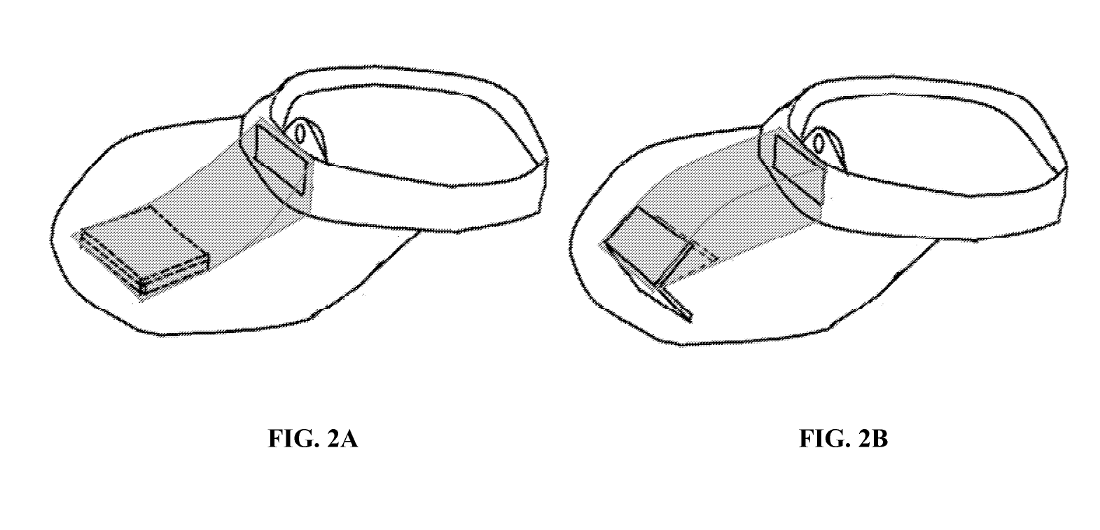

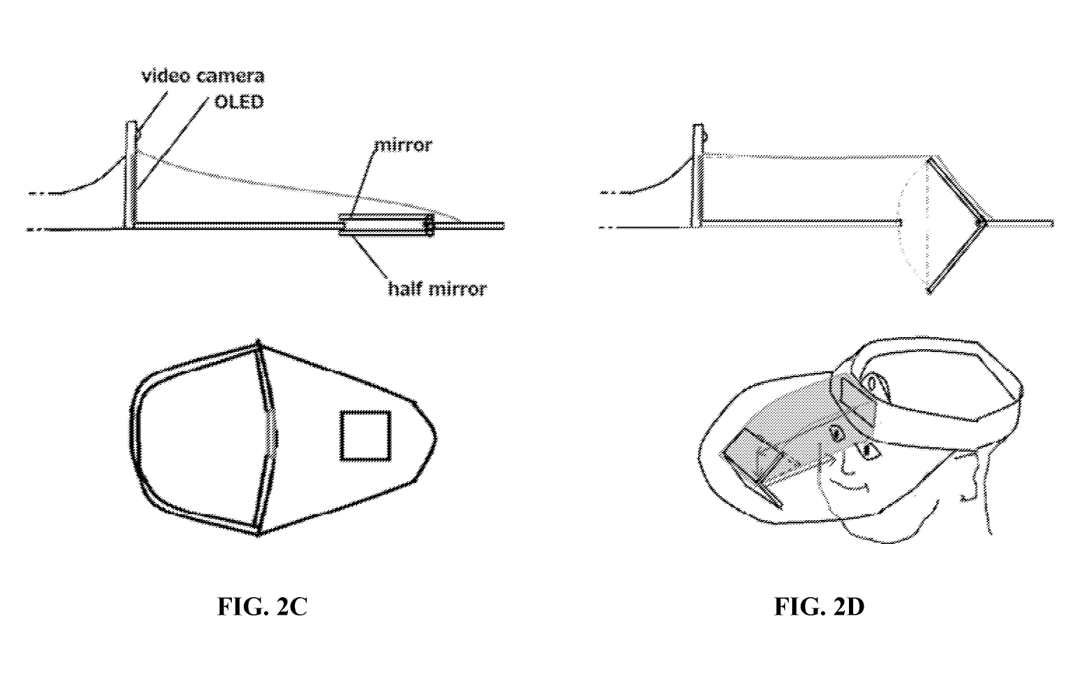

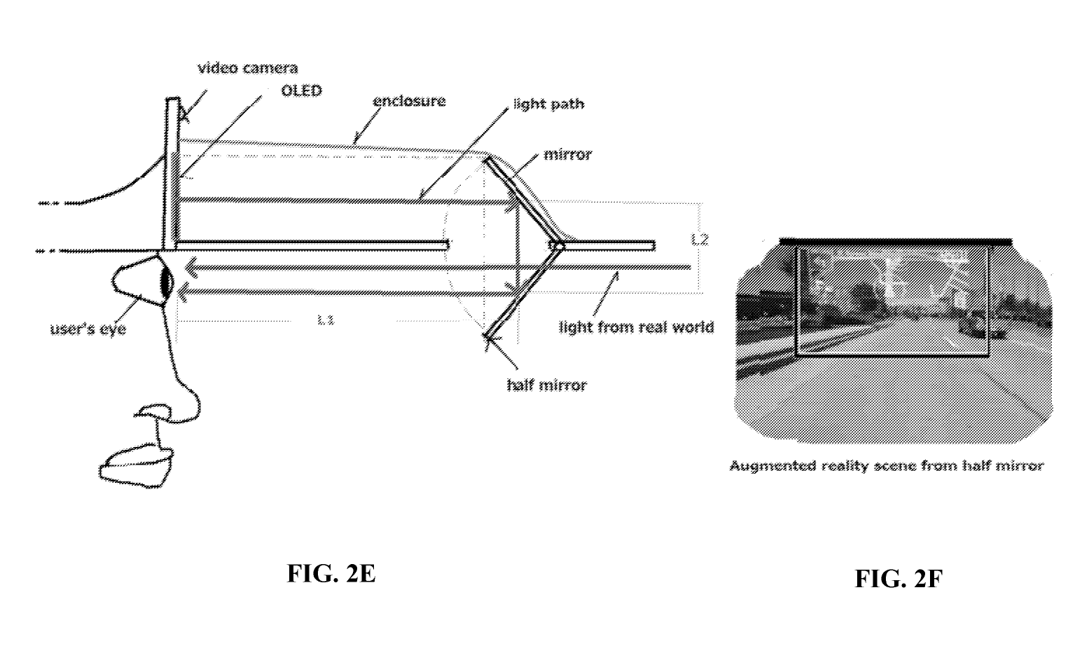

FIG. 2A is a schematic diagram illustrating the set of mirrors in the wearable device in FIG. 1A being in a closed state. FIG. 2B is a schematic diagram illustrating the set of mirrors in the wearable device in FIG. 1A being in an open state. Specifically, FIG. 2A shows that the pair of mirrors are closed when the user is not using the wearable device to display AR information. FIG. 2B shows that the pair of mirrors are opened when the user intends to use the wearable device to display AR information. As a result, the mirrors are able to receive an image displayed on the OLED screen and an outside light source, as shown and described above with respect to FIG. 1B.

FIG. 2C is a schematic diagram illustrating a side view and a top view of the set of mirrors in the wearable device in FIG. 1A being in the closed state. FIG. 2D is a schematic diagram illustrating a side view and a perspective view of the set of mirrors in the wearable device in FIG. 1A being in the open state. As shown in FIGS. 2C and 2D, the brim of the wearable device (e.g., a cap, visor, hat, etc.) has a hole to allow the reflected light from the first mirror (positioned above the brim when the mirrors are in the open state) to pass through to the second mirror (positioned under the brim when the mirrors are in the open state).

Moreover, when the mirrors are in the closed state, the first mirror is completely not facing the OLED screen, thus not reflecting the image displayed on the OLED screen. In contrast, when the mirrors are in the open state, the first mirror is partially facing the OLED screen and partially facing the second mirror, thus reflecting the image displayed on the OLED screen onto the second mirror, which in turn reflects the image to the user's eyes.

FIG. 2E is a schematic diagram illustrating a side view of the set of mirrors in the wearable device in FIG. 1A and light paths reflected by the set of mirrors. Particularly, FIG. 2E depicts the distance between the OLED screen surface and the user's eye. As shown in FIG. 2E, the total length of the light path (referred to as L) between the OLED screen and the users' eye can be calculated as (note that the first mirror is identified as “mirror” and the second mirror is identified as “half mirror” in FIG. 2E):

L=L1 (OLED screen to the first mirror)+L2 (the first mirror to the second mirror)+L1 (the second mirror to the user's eye)=2*L1+L2.

In some embodiments, L has a minimum value for achieving a clear display for a user with a normal vision. The value of L can be used to evaluate the efficient ergonomic design of the optical components of the wearable device, because it is known that human eyes cannot naturally focus on an image subject if the image subject is closer to the human eyes than a certain distance (e.g., 5 inches or about 12.7 centimeters). Therefore, the length of the light path L should be long enough for human eyes to comfortably see the image subject without any additional optical component such as adjustable lens. According to the recommendation of the medical society, the optimal range for L is about 25 to 30 centimeters.

FIG. 2F illustrates a mixed AR image displayed on the second mirror of the wearable device in FIG. 1A. As shown in FIG. 2F, an overlay AR image with a rectangle frame is mixed with and overlaid on a background real world scene. The overlay AR image includes AR objects at a top portion within the frame. As a result of such a mixed AR image being seen by the user of the wearable device, the mixed image of the AR objects and the real world scene is displayed to the user.

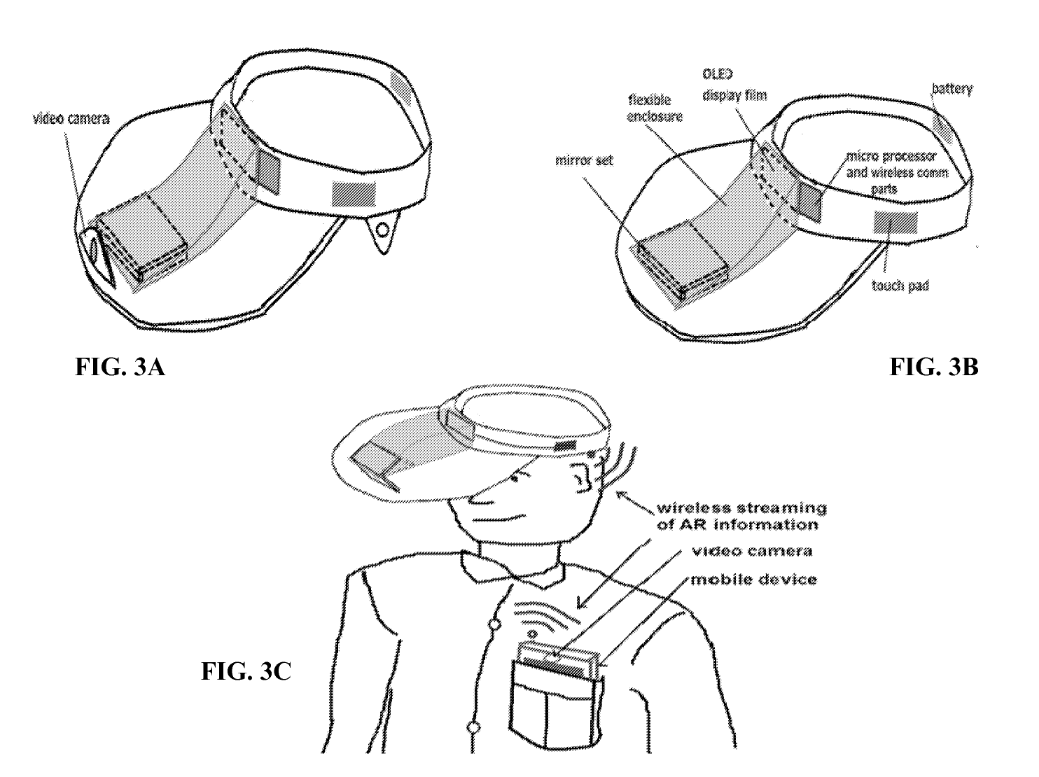

FIG. 3A is a schematic diagram illustrating a perspective view of another wearable device in accordance with some embodiments. As shown in a comparison between FIG. 1A and FIG. 3A, the wearable device of FIG. 3A differs from the one of FIG. 1A mainly in the location of the camera (e.g., video camera). Specifically, the camera of the wearable device of FIG. 1A is installed on top of the front edge of the base of the wearable device (i.e., above the OLED screen), while the camera of the wearable device of FIG. 3A is installed at the outer edge of the brim of the wearable device (i.e., in front of the mirror set). One advantage of the design for the wearable device of FIG. 3A is that the user can see a wider view angle compared to the one of FIG. 1A, which might create a possible obstruction for a wider view angle due to the expansion of the flexible enclosure in front of the camera.

FIG. 3B is a schematic diagram illustrating a perspective view of yet another wearable device in accordance with some other embodiments. FIG. 3C is a schematic diagram illustrating the wearable device in FIG. 3B being worn by a user. As shown in FIGS. 3B and 3C, the wearable device does not have a camera. Instead, the wearable device communicates (e.g., wirelessly) with a mobile device (e.g., a smart phone, a video camera, etc.) to obtain an overlay AR image. To be specific, the mobile device is equipped with a camera (e.g., video camera) that can capture an image of a real world scene. The mobile device can also process the captured image to identify or generate AR information (e.g., AR objects) corresponding to the real world scene. The mobile device then can generate the overlay AR image including the AR information. Finally, the wearable device can receive the overlay AR image or the AR information (wirelessly) from the mobile device, as shown in FIG. 3C.

In the embodiment shown in FIGS. 3B and 3C, the function of the hardware design of the wearable device can be limited to display the AR information or the overlay AR image that is wirelessly streamed from the mobile device. The mobile device itself can execute the entire AR image processing, and then wirelessly stream the resulted data of AR information or overlay AR image (e.g., a 2-dimensional (2D) or 3-dimensional (3D) computer graphic image) to the wearable device. In other words, the hardware design of the wearable device can be limited to provide a minimum function of displaying AR information only.

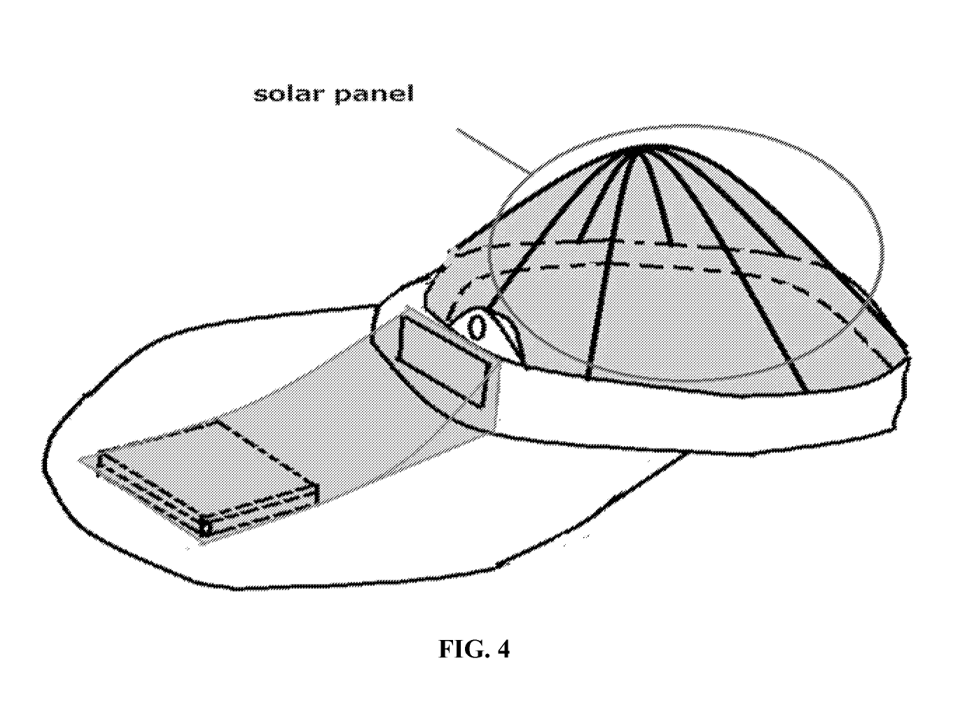

FIG. 4 is a schematic diagram illustrating a wearable device with a solar panel in accordance with some embodiments. As shown in FIG. 4, the wearable device can include one or multiple pieces of solar panel on top of the base to provide electrical energy to the computer system and electronic components of the wearable device. In some embodiments, the wearable device can also include components to generate and provide other types of energy (e.g., wind energy).

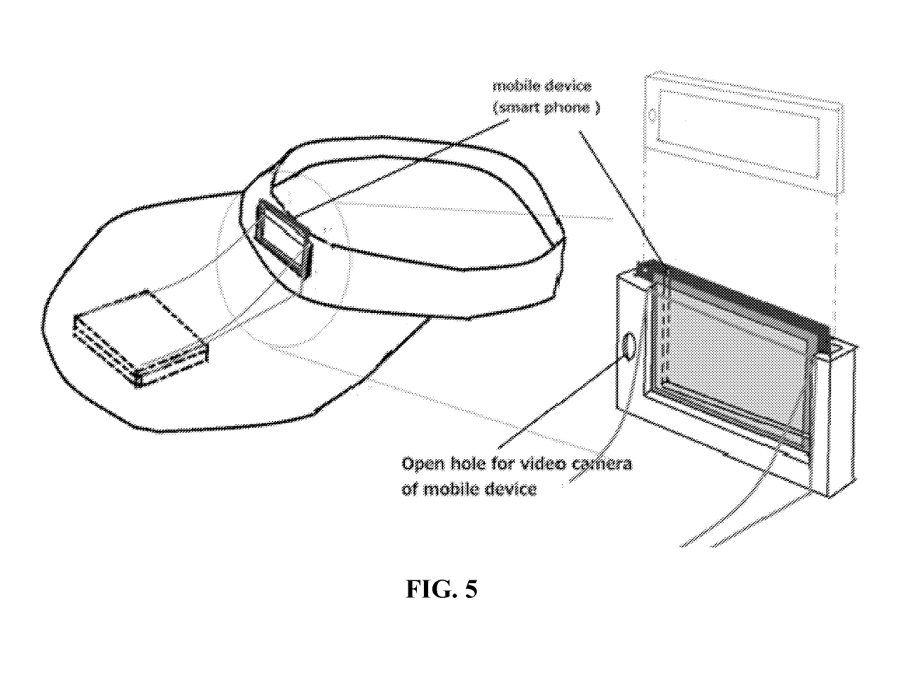

FIG. 5 is a schematic diagram illustrating a wearable device with a mobile device in accordance with some embodiments. As shown in FIG. 5, the wearable device replaces the OLED screen with a mobile device having a screen. Such a mobile device can be, for example, a smart phone or any suitable device that has a display device (e.g., a screen). The mobile device can be installed at the front edge of the base, in the same location as the OLED screen in the wearable device of FIG. 1A. As shown in FIG. 5, the mobile device can be installed within an enclosure with an open hole to expose the camera of the mobile device. In other embodiments, the mobile device can be installed at any other suitable location of the wearable device. Furthermore, in some embodiments, similar to the wearable device of FIGS. 3B and 3C, the mobile device itself can be responsible for executing the AR image processing to generate an overlay AR image, and then displaying the overlay AR image on this screen.

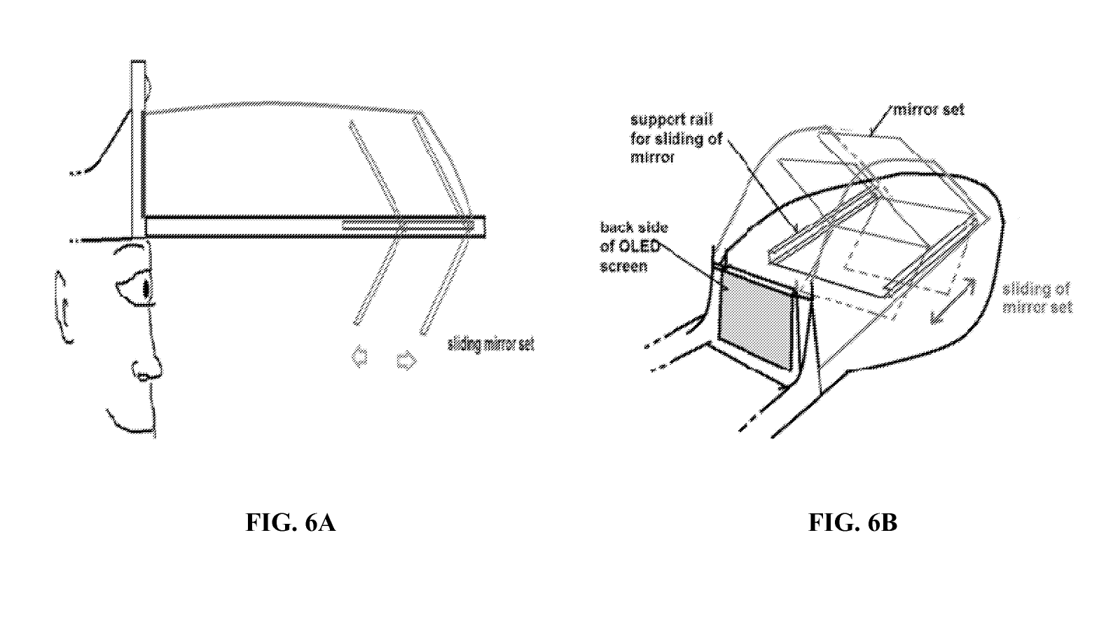

FIGS. 6A and 6B are schematic illustrations of a sliding feature for a set of mirrors in a wearable device in accordance with some embodiments. As shown in FIGS. 6A and 6B, the wearable device includes a pair of support rails for sliding the mirrors further away from the user's eyes or closer to the user's eyes. Consequently, the distance between the mirror set and the user's eyes is movably adjustable. In other words, the effective length of the light path from the screen to the user's eyes (L) can be increased or decreased. As a result, the wearable device allows the user to make fine tuning of image focus to the user's eyes.

In some embodiments, software installed on the wearable device described herein includes firmware installed in a CPU/GPU (central processing unit/graphics processing unit) module of the wearable device and AR application software installed in a user-level software storage of the wearable device.

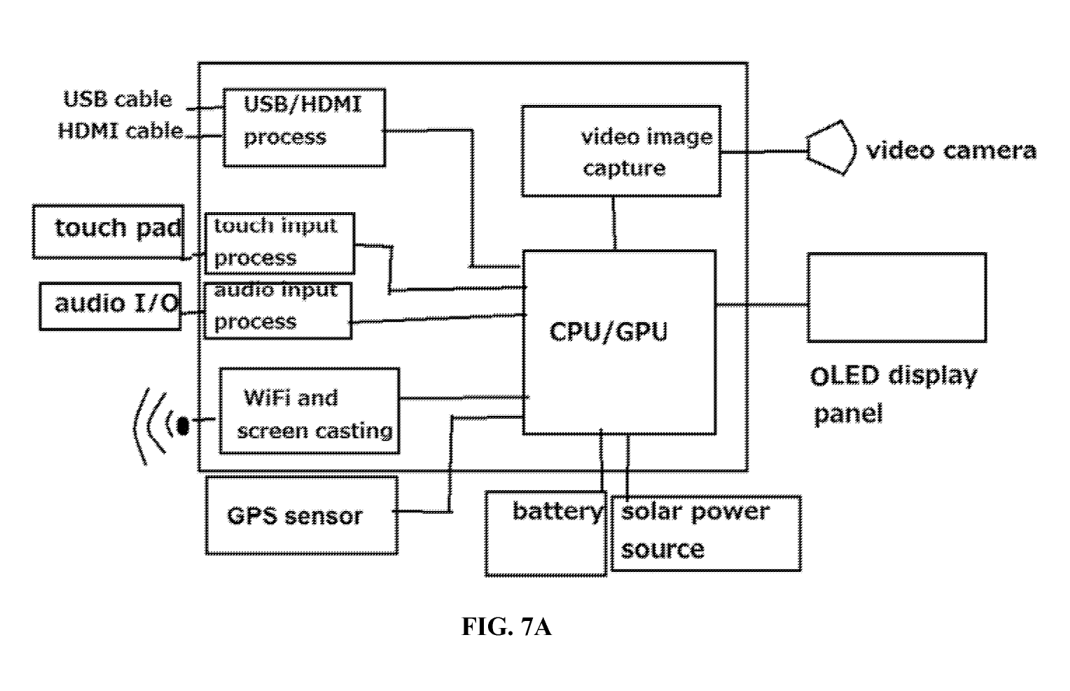

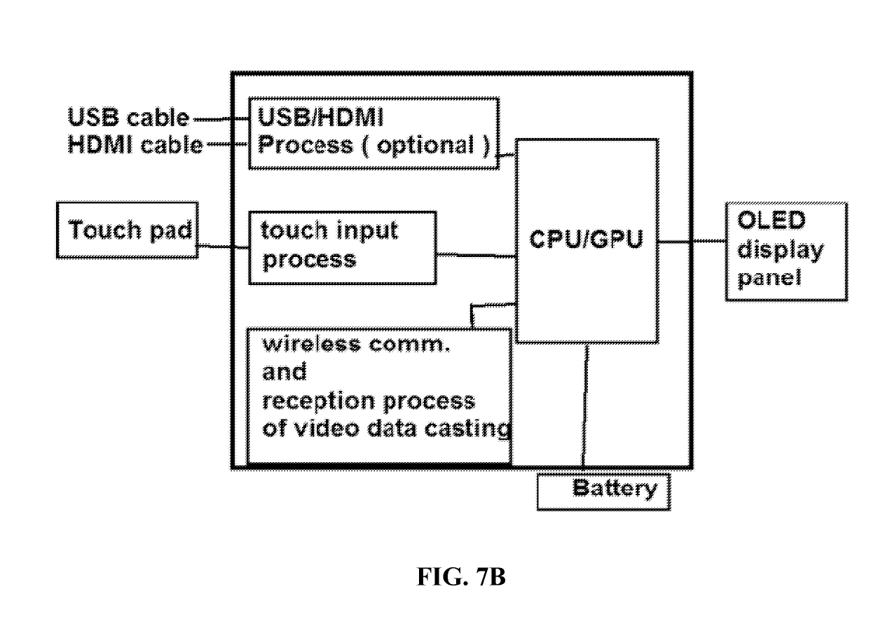

FIG. 7A is a block diagram illustrating components and modules of the wearable device in FIG. 1A and/or FIG. 3A. The firmware of the wearable device has processing functions similar to the one provided by the known conventional wearable devices (e.g., Google Glass) or the currently available smart phones (e.g., iPhone). As shown in FIG. 7A, those functions include, for example, video camera capturing and processing, USB support, HDMI (high-definition multimedia interface) input/output support, touchpad based input support, audio input/output processing, GPS sensing, WiFi communication (e.g., Internet connection) and screen casting (e.g., video streaming function such as Miracast), etc. Some of the functions are optional, such as, for example, audio input/output processing, GPS sensing, etc. Additionally, the firmware of the wearable device can also include other functions such as, for example, displaying images on the OLED screen, generating energy using the solar panel, managing battery power, etc.

FIG. 7B is a block diagram illustrating components and modules of the wearable device in FIG. 3B. Different from the firmware functions shown and described with respect to FIG. 7A, the firmware of the wearable device in FIG. 7B has limited processing functions to execute image displaying, wireless communication, and reception of data streaming Specifically, as shown in FIG. 7B, the firmware functions include, for example, wireless communication (e.g., Bluetooth, WiFi, etc.) with the mobile device, receiving image/video data casting or streaming from the mobile device, displaying the overlay AR image or AR information on the OLED screen, etc. Additionally, the wearable device can have optional firmware functions such as, for example, touchpad input processing, battery management, USB/HDMI signal processing, etc.

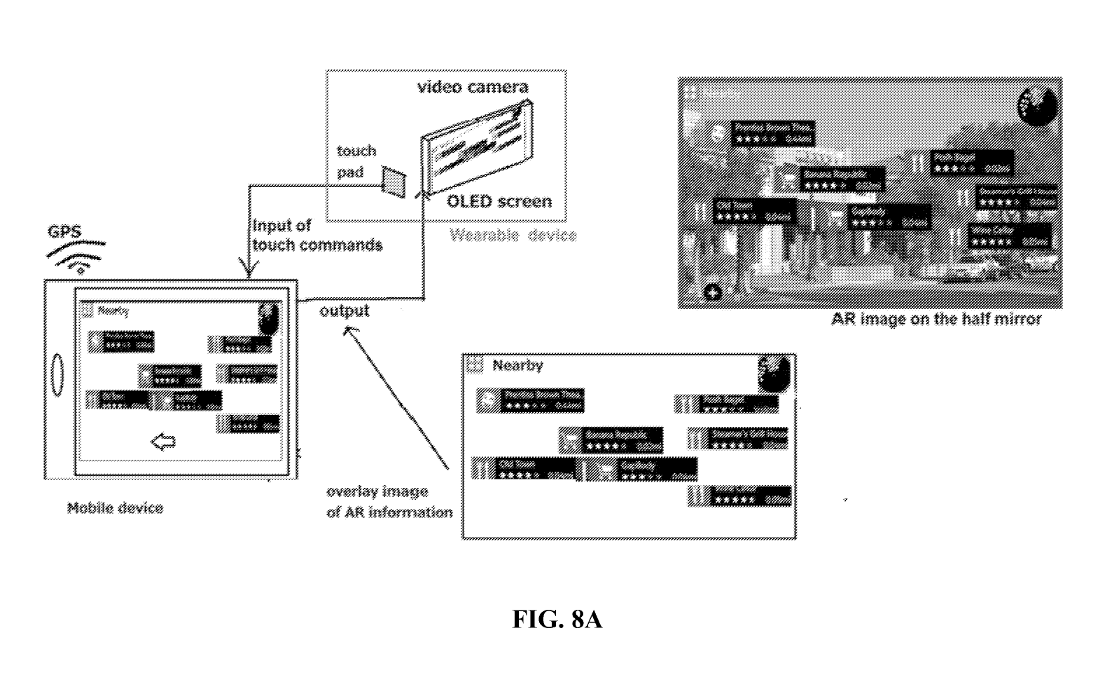

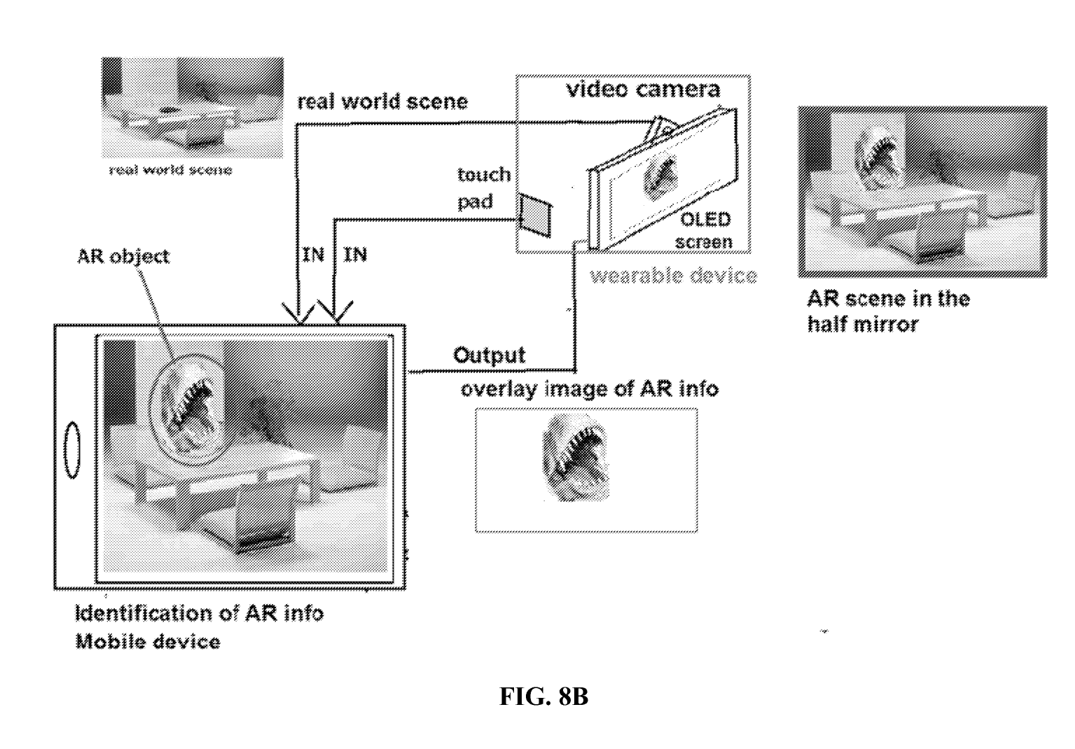

FIG. 8A is a schematic illustration of a mobile device (e.g., smart phone) configured to generate an overlay AR image for the wearable device in FIG. 3B. As shown in FIG. 8A, the wearable device simply provides touch input commands to the mobile device using the touch pad. The mobile device executes the necessary AR application process. For example, the mobile device detects GPS data to determine a current location of the user (or a real world scene associated with the current location of the user), and then identifies AR information (e.g., AR objects as shown in FIG. 8A) for the determined location (or real world scene). The mobile device then outputs real-time video frame streaming of an overlay AR image including the AR information to the wearable device. Subsequently, the wearable device displays the overlay AR image on its OLED screen. A mixed image of AR information and the real world scene is shown on top right of FIG. 8A. Such a mixed image can be generated at the second mirror of the wearable device by overlaying the overlay AR image received from the mobile device on top of the real world scene.

In some embodiments, the CPU/GPU process of capturing images of real world scenes for the wearable device described herein (e.g., by a camera of the wearable device) is different from that for conventional smart phones. In the case of smart phones, the captured image is sent to the CPU/GPU module. Then, raw data (e.g., pixel frames of the video data) of the image is processed for being displayed in a screen unit (e.g., a LED (light-emitting diode) screen unit) of the smart phone. In other words, the smart phone directly transfers the post-processed video frame to display the image of the real world scene in the screen (e.g., a LCD screen) of the smart phone.

In contrast, in the case of the wearable device described herein, the wearable device captures an image of the real world scene using, for example, a built-in video camera. Then the CPU/GPU module of the wearable device utilizes the video frame data to identify AR information (e.g., AR targets, AR objects) corresponding to the real world scene. However, the wearable device does not necessarily transfer the complete image of the real world scene to a screen unit (e.g., a LED screen unit) of the wearable device. In other words, the wearable device can suppress the data transfer of video frames to its screen unit. Once the AR information is identified and rendered by the CPU/GPU module, the wearable device displays the overlay AR image, which includes the AR information but not elements from the captured image of the real world scene, on the screen (e.g., a LCD screen) of the wearable device. Subsequently, the overlay AR image displayed on the screen is reflected to the mirror set of the wearable device. As a result, the user can watch, through the second mirror, the mixed image of the AR information being overlaid on the real world scene as the background.

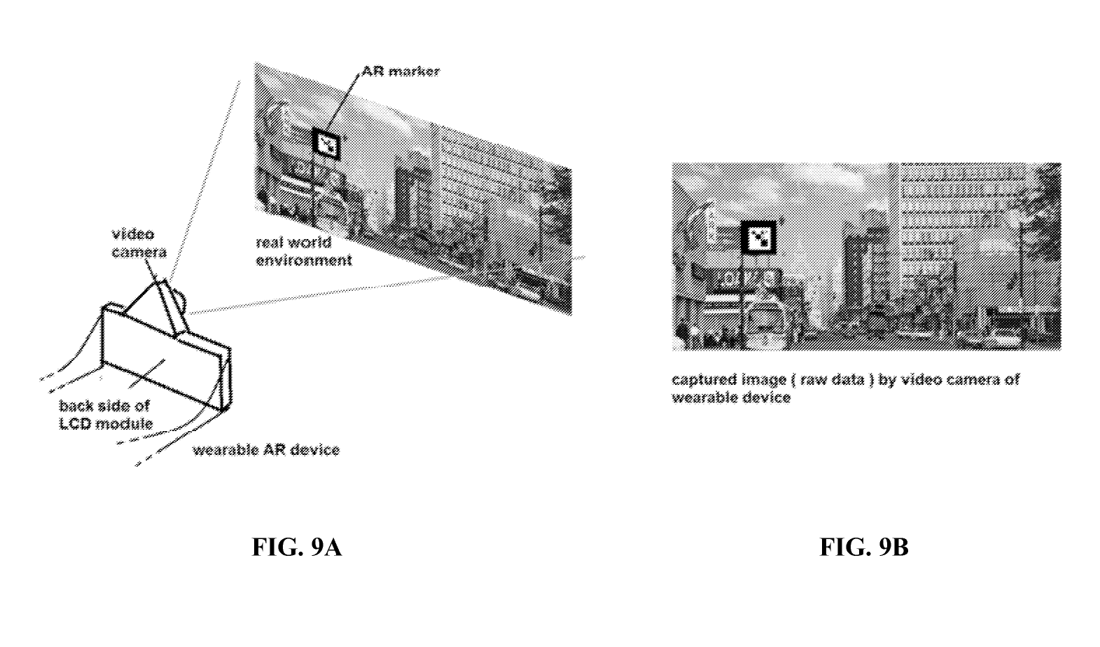

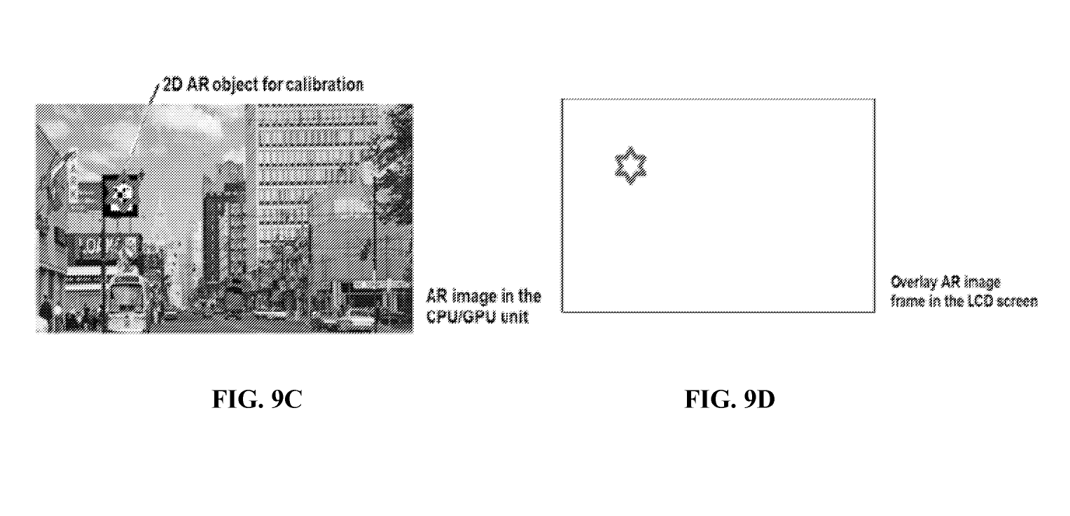

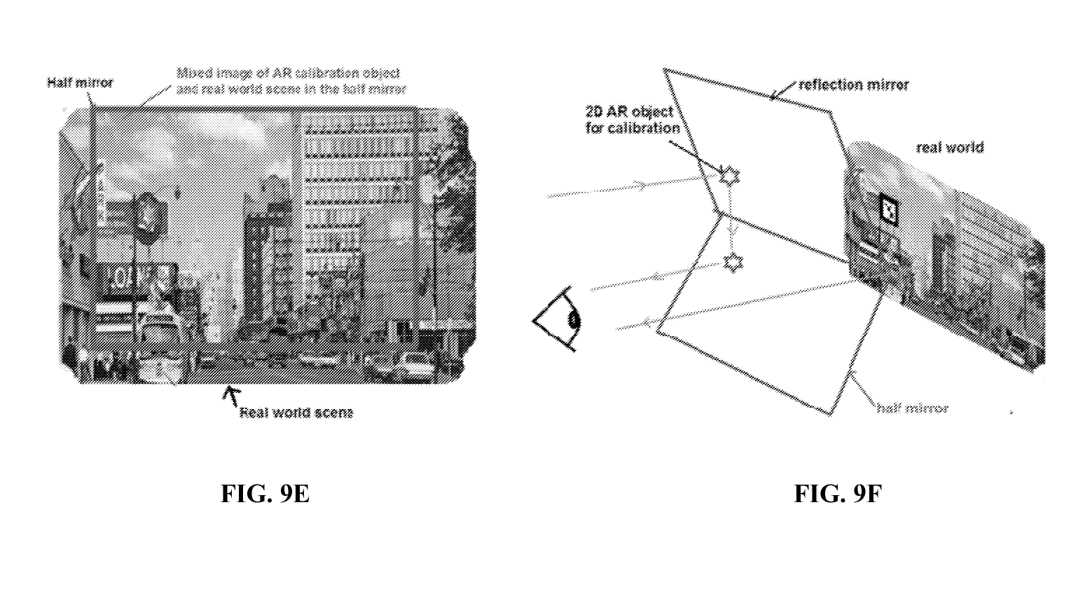

In some embodiments, in order to obtain a correct 2D position of the overlay AR image in the second mirror (i.e., half-silvered mirror) of a wearable device, a calibration of the camera and the mirror set of the wearable device can be performed. Such a calibration is to perform a 3D position alignment of the camera and/or the mirror set to obtain focus matching. As an example, a basic method for calibration is shown in FIGS. 9A-9F and described as follows.

FIGS. 9A-9F depict how to calibrate the view area of a camera and a mirror set of a wearable device to match the 2D position of AR information and the 2D position of the overlay AR image. Specifically, FIG. 9A is a schematic diagram illustrating a perspective view of a camera of the wearable device in FIG. 1A and an image of a real world scene captured by that camera. FIG. 9B illustrates the captured image of the real world scene in FIG. 9A from another view angle. FIG. 9C illustrates processing the captured image of the real world scene in FIG. 9A to identify an AR object. FIG. 9D illustrates an overlay AR image as a result of the processing shown in FIG. 9C. FIG. 9E illustrates a mixed image of the real world scene and the overlay AR image in FIG. 9D. FIG. 9F is a schematic diagram illustrating the set of mirrors in the wearable device in FIG. 1A generating the mixed image in FIG. 9E.

Described in another way, FIGS. 9A and 9B illustrate the capturing of the image of the real world scene by the camera (e.g., video camera) installed on the wearable device. The captured image in FIG. 9B is processed by a CPU/GPU module of the wearable device to detect an AR target image (i.e., an image having at least one AR marker) and to identify at least one AR object (i.e., the star shape object in FIG. 9C) for calibration, as shown in FIG. 9C. FIG. 9A shows a billboard as an AR marker. The position of the AR marker in the AR target image is where a corresponding AR object (i.e., the star shape object) is supposed to be in a mixed image that is ultimately displayed to the user.

The image shown in FIG. 9C renders the AR object on the captured image of the real world scene. The CPU/GPU module of the wearable device can then generate the overlay AR image (shown in FIG. 9D), which includes the AR object but not elements from the captured image of the real world scene, based on the image shown in FIG. 9C. Such an overlay AR image shown in FIG. 9D is then transferred to a screen unit (e.g., LED screen unit) of the wearable device to be displayed on a screen (e.g., a LCD or LED screen) of the wearable device.

As a result, as shown in FIG. 9F, the overlay AR image is reflected to the first mirror (identified as the “reflection mirror” in FIG. 9F), then further reflected to the second mirror (identified as the “half mirror” in FIG. 9F). Particularly, the AR object (i.e., the star shape object) included in the overlay AR image (shown in FIG. 9D) is reflected to the first mirror and then further reflected to the second mirror, as shown in FIG. 9F. Meanwhile, a real world scene passes through the second mirror and is seen by the user's eyes, as shown in FIG. 9F. Thus, the second mirror provides a mixed image of the overlay AR image (that is, the AR object) and the real world scene to the user, as shown in FIG. 9F. The resulted mixed image is shown in FIG. 9E.

During this process, the AR marker (i.e., the billboard identified in FIG. 9A) and the AR object (i.e., the start shape object in FIGS. 9C-9F) are used for calibration. In other words, the user can estimate how close the 2D location of the AR marker and the 2D location of the AR object are in the mixed image of FIG. 9E, which reflects the alignment of the camera and the mirror set of the wearable device. Generally, the closer the AR marker and the AR object are in the mixed image, the better alignment of the camera and mirror set. In some embodiments, when the AR object is completely overlapped with the AR marked in the mixed image that is ultimately displayed to the user, it indicates a perfect alignment of the camera and the mirror set.

In some embodiments, the firmware of a wearable device described herein can have two operation modes: a default mode, and a slave mode under a mobile device that functions as a master device. At the default mode, the firmware can execute (substantially) all the functions by the hardware resources of the wearable device. At the slave mode, the firmware can function as, for example, an input peripheral for the connected mobile device. The mobile device, on the other hand, can function as a master computer system to execute (substantially) all the AR application related processes.

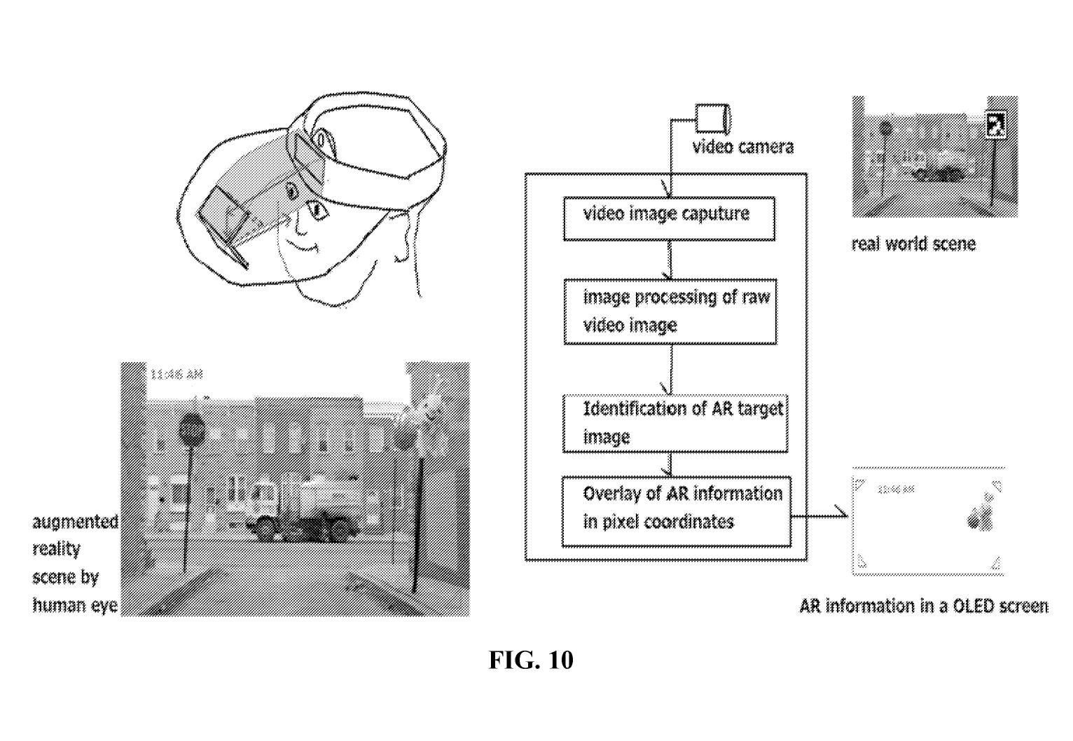

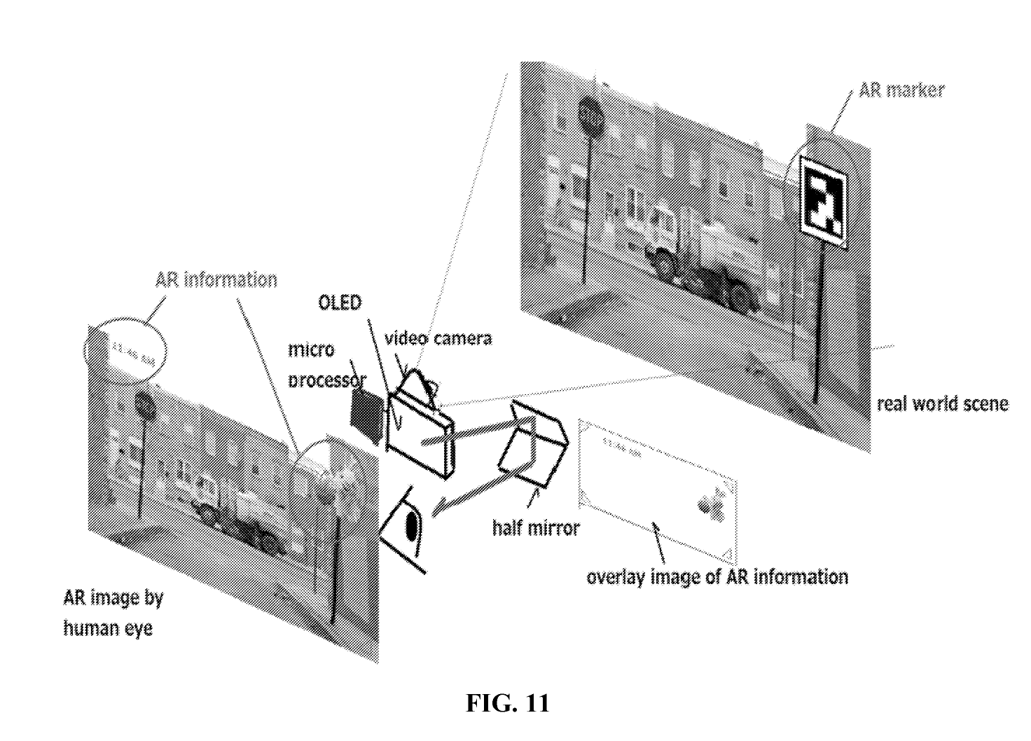

As an example, FIGS. 10 and 11 depict an AR application process performed by a wearable device under the default mode. FIG. 10 is a schematic illustration of mixing an overlay AR image with a real world scene in accordance with some embodiments. FIG. 11 is another schematic illustration of the mixing process shown in FIG. 10. Specifically, the camera (e.g., video camera) of the wearable device can capture a raw image of the real world scene. The CPU/GPU of the wearable device can run an AR image processing program on the raw image to identify an AR marker at the top right portion of the captured image, as shown in the small image at the top right corner of FIG. 10. In some embodiments, for example, data of AR markers is stored in a database within a storage (e.g., a memory) of the wearable device. In such embodiments, the CPU/GPU can search through the database based on information (e.g., location, landmark, etc.) of the captured image to identify the corresponding AR marker(s).

Subsequently, the CPU/GPU of the wearable device can identify AR information (e.g., AR object) corresponding to the identified AR marker. In the example of FIGS. 10 and 11, the AR information is a 3D rabbit shown in the small image at the bottom left corner of FIG. 10. Then, the CPU/GPU can generate an overlay AR image (shown in the bottom right corner of FIG. 10) that includes the AR information and a current time, but not other elements from the captured image. Such an overlay AR image can be displayed on a screen (e.g., OLED screen) of the wearable device. Consequently, the overlay AR image can be reflected through the first mirror to the second mirror. Meanwhile, the user can see the same (or substantially the same) real world scene through the second mirror. Thus, the user can see the mixed image of the real world scene and the AR information, where the AR object (i.e., 3D rabbit) is displayed at the location of the AR marker) and the current time is displayed on the top left corner of the mixed image. FIG. 11 shows the realization process described above from an optical hardware viewpoint.

In some embodiments, as described herein, a mobile device can perform partial or all AR image processing functions when a wearable device is not equipped with sufficient data processing capability. FIGS. 8A and 8B depict a collaborative configuration between a wearable device and a mobile device under such a scenario. Specifically, FIG. 8A is a schematic illustration of a mobile device configured to generate an overlay AR image for the wearable device in FIG. 3B, and FIG. 8B is another schematic illustration of a mobile device configured to generate an overlay AR image in accordance with some embodiments. Both FIGS. 8A and 8B illustrate that the mobile device functions as a master device and the wearable device is in the slave mode.

FIG. 8A shows that the wearable device is used as a display peripheral for location-based AR information display. The mobile device and the touch pad of the wearable device can be connected through, for example, a USB port of the wearable device. In response to receiving a command from the touch pad (e.g., manually entered by the user of the wearable device), the mobile device can utilize, for example, its GPS data to obtain the location-based AR information (e.g., the 2D AR messages in FIG. 8A) corresponding to the current location of the user (or equivalently, the current location of the mobile device or the wearable device). In some embodiments, the mobile device can communicate with, for example, an AR server through the Internet to retrieve the AR information.

Once the mobile device acquires the appropriate AR information, the mobile device can generate an overlay AR image including the AR information, as shown in FIG. 8A. The mobile device can then transmit the overlay AR image to the OLED screen of the wearable device by, for example, a connection through a HDMI cable or WiFi direct video/image streaming (e.g., Miracast). As a result, the user can see a mixed image of a real world scene and the location-based AR information (i.e., the 2D AR messages) through the second mirror of the wearable device, as shown in FIG. 8A.

FIG. 8B shows that the wearable device is used as a camera and display device of AR information. The mobile device and the touch pad of the wearable device can also be connected through a USB port or any other suitable method. Upon receiving a command from the touch pad of the wearable device (e.g., manually entered by the user), the mobile device can acquire raw data (e.g., image or video data) from the camera of wearable device through, for example, a HDMI cable or WiFi direct data streaming (e.g. Miracast). Then, the mobile device can execute an AR application program for AR image recognition. Once the mobile device detects a specific AR target image, the mobile device can acquire corresponding AR information (e.g., a 3D AR dinosaur head as shown in FIG. 8B) for the AR target image from, for example an AR server through the Internet. The mobile device can then generate an overlay AR image including the AR information. Next, the mobile device can transfer the overlay AR image to the OLED screen of the wearable device by, for example, a connection through a HDMI cable or WiFi direct data streaming (e.g., Miracast). As a result, the user can see a mixed image of a real world scene and the AR information (i.e., the 3D AR dinosaur head) through the second mirror of the wearable device, as shown in FIG. 8B.

The foregoing description, for purpose of explanation, has been described with reference to specific embodiments. However, the illustrative discussions above are not intended to be exhaustive or to limit the present application to the precise forms disclosed. Many modifications and variations are possible in view of the above teachings. The embodiments were chosen and described in order to best explain the principles of the present application and its practical applications, to thereby enable others skilled in the art to best utilize the present application and various embodiments with various modifications as are suited to the particular use contemplated.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the present application herein is for the purpose of describing particular embodiments only and is not intended to be limiting of the present application. As used in the description of the present application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

What is claimed is:

1. A wearable device configured to display augmented reality (AR) information to a user wearing the wearable device, the wearable device comprising a screen and a set of mirrors including a first mirror and a second mirror,
the screen being configured to display an overlay AR image including AR information associated with a real world scene of a surrounding environment of the user;
the first mirror being configured to reflect the overlay AR image displayed on the screen to the second mirror; and
the second mirror being configured to simultaneously a) receive and reflect the overlay AR image reflected by the first mirror and b) transmit the real world scene, such that the second mirror displays a mixed image of the AR information and the real world scene to the user.

2. The wearable device of claim 1, wherein the first mirror is a full-reflective mirror and the second mirror is a half-silvered mirror.

3. The wearable device of claim 1, wherein the screen is an organic light-emitting diode (OLED) screen.

4. The wearable device of claim 1, wherein the wearable device further comprises a camera and a processing device, the camera configured to capture the real world scene, the processing device configured to identify the AR information and to generate the overlay AR image based on the captured real world scene.

5. The wearable device of claim 4, wherein the camera is configured to generate an image of the real world scene and the processing device is configured to identify the AR information and to generate the overlay AR image using the image as an input.

6. The wearable device of claim 1, wherein the wearable device is configured to receive the overlay AR image from a mobile device of the user.

7. The wearable device of claim 1, wherein the wearable device further comprises a camera and a connector, the camera configured to capture the real world scene, the connector configured to send information of the captured real world scene to a mobile device of the user and receive the overlay AR image from the mobile device of the user.

8. The wearable device of claim 1, wherein the second mirror is configured to receive the overlay AR image from the first mirror when the set of mirrors are in an open state, and the second mirror is configured not to receive the overlay AR image from the first mirror when the set of mirrors are in a closed state.

9. The wearable device of claim 1, wherein the distance between the second mirror and eyes of the user is movably adjustable.

10. A wearable device configured to display augmented reality (AR) information to a user wearing the wearable device, the wearable device comprising a camera, a processing device, a screen and a set of mirrors including a first mirror and a second mirror,
the camera being configured to capture a real world scene of a surrounding environment of the user;
the processing device being configured to identify AR information associated with the real world scene and generate an overlay AR image including the AR information based on the captured real world scene;
the screen being configured to display the overlay AR image;
the first mirror being configured to reflect the overlay AR image displayed on the screen to the second mirror; and
the second mirror being configured to simultaneously a) receive and reflect the overlay AR image reflected by the first mirror and b) transmit the real world scene, such that the second mirror displays a mixed image of the AR information and the real world scene to the user.

11. The wearable device of claim 10, wherein the first mirror is a full-reflective mirror and the second mirror is a half-silvered mirror.

12. The wearable device of claim 10, wherein the second mirror is configured to receive the overlay AR image from the first mirror when the set of mirrors are in an open state, and the second mirror is configured not to receive the overlay AR image from the first mirror when the set of mirrors are in a closed state.

13. The wearable device of claim 10, wherein the distance between the second mirror and eyes of the user is movably adjustable.

14. The wearable device of claim 10, wherein the screen is an organic light-emitting diode (OLED) screen.

15. A method of displaying augmented reality (AR) information to a user wearing a wearable device, comprising:
displaying, on a screen of the wearable device, an overlay AR image including AR information associated with a real world scene of a surrounding environment of the user;
reflecting the overlay AR image displayed on the screen onto a first mirror of the wearable device and further onto a second mirror of the wearable device; and
displaying, at the second mirror, a mixed image of the AR information and the real world scene to the user.

16. The method of claim 15, further comprising, prior to displaying the overlay AR image:
capturing the real world scene of the surrounding environment of the user; and
identifying the AR information and generating the overlay AR image based on the captured real world scene.

17. The method of claim 16, wherein the capturing the real world scene includes generating an image of the real world scene using a camera of the wearable device.

18. The method of claim 15, further comprising, prior to displaying the overlay AR image:
receiving the overlay AR image from a mobile device of the user.

19. The method of claim 15, further comprising, prior to displaying the overlay AR image:
capturing the real world scene of the surrounding environment of the user;
sending information of the captured real world scene to a mobile device of the user; and
receiving the overlay AR image from the mobile device of the user.

20. The method of claim 15, wherein the first mirror is a full-reflective mirror and the second mirror is a half-silvered mirror.
